(19) United States
(12) Patent Application Publication
(10) Pub. No.: US 2026/0234899 A1
(43) Pub. Date: Aug. 13, 2026

(54) Method Of Adjusting Relief Pressure Of Relief Valve For Swing Motor

(71) Applicant: Caterpillar SARL, Geneva (CH)

(72) Inventor: Naoki Sawada, Akashi-shi, Hyogo (JP)

(21) Appl. No.: 19/149,607

(22) PCT Filed: Jan. 26, 2024
(86) PCT No.: PCT/EP2024/025049

§ 371 Date: Jul. 21, 2025

(30) Foreign Application Priority Data
Jan. 27, 2023 (JP) 2023-010601

(51) Int. Cl. E02F 9/12; F15B 13/02

(52) U.S. Cl. CPC E02F 9/123; F15B 13/024; E02F 9/128; F15B 2211/55

(57) ABSTRACT

A method is provided for adjusting the relief pressure of a relief valve for a swing motor that can set the relief pressure of each relief valve with high accuracy without rotating the upper swing body. Sequentially switching the relief valve for the swing motor to be adjusted; and at a state that the rotation of each swing motor is forcibly stopped and the relief pressure of the relief valve for a swing motor to be adjusted is less than the relief pressure of the relief valve for the other swing motor, performing a process of adjusting the relief pressure of the relief valve for the swing motor to be adjusted while supplying the working oil from the pump at a flow rate less than the maximum flow rate of the swing motor.

### TECHNICAL FIELD

The present invention relates to a method of adjusting relief pressure of a relief valve for a plurality of swing motors that swivel a swing body of a working machine.

### BACKGROUND

In hydraulically driven working machines, the various relief valves provided in the hydraulic circuit can obtain the desired performance in each part driven by the appropriate setting of the relief pressure (see, e.g., Patent Documents 1 and 2).

### PRIOR ART DOCUMENTS

### Patent Documents

Patent Document 1: JP 1999-94105A
Patent Document 2: JP 1993-60105A

### SUMMARY OF THE INVENTION

### Problems to be Solved by the Invention

For example, a relief valve is also set in the hydraulic motor, which is a fluid pressure actuator (fluid pressure motor) for rotating the upper swing body of the working machine, and the relief pressure is directly connected to the performance of the swivel torque. For example, when the relief pressure is set at a low level, it is easier to be unable to swivel in the inclined direction due to insufficient acceleration torque on the slope, or to increase the flow of swivel due to insufficient brake torque.

In particular, in the case of large working machines, two swing motor units may be provided. Each of these units is provided with a relief valve, and there will be two relief valves on the same system. Then, by equidistribution of the hydraulic oil supplied from the pump to each unit, each relief valve is operated at a flow rate of ½ of the pump flow rate, which is the sum of the maximum flow rate of the swing motor. Therefore, it is desirable that the relief pressure be set under this flow condition.

However, in the case of the swing motor unit, when the hydraulic oil is flowed and driven like other pumps and motors at the time of adjusting the pressure of the relief valve, the upper swing body will rotate, so a large amount of space is required, especially for large working machines, which is not practical. Therefore, when actually adjusting the pressure of the relief valve, the swing motor unit is forced to stop so that the upper swing body does not swivel. In that case, it is easy for the flow rate on either side of the relief valve to be too large or too small without equal distribution of the pump flow rate due to a balance such as piping pressure drop, making it difficult to adjust the pressure with high accuracy.

In addition, when adding circuits for pressure adjustment, additional piping is required, which makes it more complicated, increases the number of parts, and increases the risk of oil leakage.

In view of this, it is an object of the present invention to provide a method for adjusting the relief pressure of a relief valve for a swing motor that can set the relief pressure of each relief valve with high accuracy without swiveling the swing body.

### Means for Solving the Problem

The invention according to claim 1 is a method for adjust relief pressure of a relief valve for a swing motor of a working machine, wherein the step of adjusting the relief pressure of the relief valve for the swing motor to be adjusted is performed by sequentially switching the relief valve for the swing motor to be adjusted meanwhile supplying the working fluid from the pump with a flow rate less than or equal to the maximum flow rate of the swing motor under a state that the rotation of each swing motor is forced to stop and the relief pressure of the relief valve for the swing motor to be adjusted is lower than the relief pressure of the relief valve for the other swing motor.

According to the invention of claim 2, in the method for adjusting relief pressure of a relief valve for a swing motor according to claim 1, the relief pressure of the relief valve for one swing motor is set higher than the relief pressure of the relief valve for the other swing motor while the swing motor is set in pairs and the rotation of each swing motor is forced to be stopped, the relief pressure of the relief valve for the other swing motor is adjust while supplying working fluid from the pump at a flow rate below the maximum flow rate of the swing motor, the relief pressure of the relief valve for one swing motor is set to be lower than the relief pressure of the relief valve for the other swing motor adjusted in the first step, and the relief pressure of the relief valve for one swing motor is adjusted while supplying the working fluid from the pump at a flow rate below the maximum flow rate of the swing motor.

According to the invention of claim 3, in the method for adjusting the relief pressure of a relief valve for a swing motor according to claim 2, a path for one swing motor to supply a working fluid from a pump is shorter than that of the other swing motor.

According to the invention of claim 4, the flow rate of the working fluid supplied when adjusting the relief pressure in the method for adjusting the relief pressure of a relief valve for a swing motor according to any one of claims 1 to 3 is a maximum flow rate of the swing motor, respectively.

### Effect of the Invention

According to the invention of claim 1, the pressure relief for a plurality of swing motors is set in a priority order, and the total flow rate is concentrated on the pressure relief valve for the swing motor to be adjusted, so that the pressure relief of each pressure relief valve can be set with high accuracy without rotating the swing body.

According to the invention of claim 2, the setting of the relief pressure is prioritized to concentrate the total flow rate to one of them by means of the relief valve for one swing motor and the relief valve for the other swing motor, such that the relief pressure of each of the relief valves can be set with high accuracy without rotating the swing body.

According to the invention of claim 3, it is possible to adjust the pressure in a state where the pressure loss of the supply line of the working fluid is as small as possible, and the relief pressure can be set with higher accuracy.

According to the invention of claim 4, the relief pressure can be set at the maximum state of the flow rate supplied to one swing motor or the other swing motor when the swing body is actually swivel, so that when the swing body is actually swivel, the swivel torque as intended can be obtained.

### BRIEF DESCRIPTION OF THE DRAWINGS

FIG. 1 illustrates an embodiment of a method for adjusting relief pressure of a relief valve for a swing motor according to the present invention, wherein (a) is a fluid pressure circuit diagram showing a first step, and (b) is a graph showing relief pressure settings of the relief valve in the first step.

FIG. 2(a) is a fluid pressure circuit diagram showing a second step, and (b) is a graph showing the relief pressure setting of the relief valve in the second step.

FIG. 3 is a fluid pressure circuit diagram illustrating an operating state under relief pressure set by a method for adjusting relief pressure of a relief valve for the above swing motor.

FIG. 4 is a side view illustrating a working machine comprising the above fluid pressure circuit.

### DETAILED DESCRIPTION

Embodiments of the present invention will be described below with reference to the drawings.

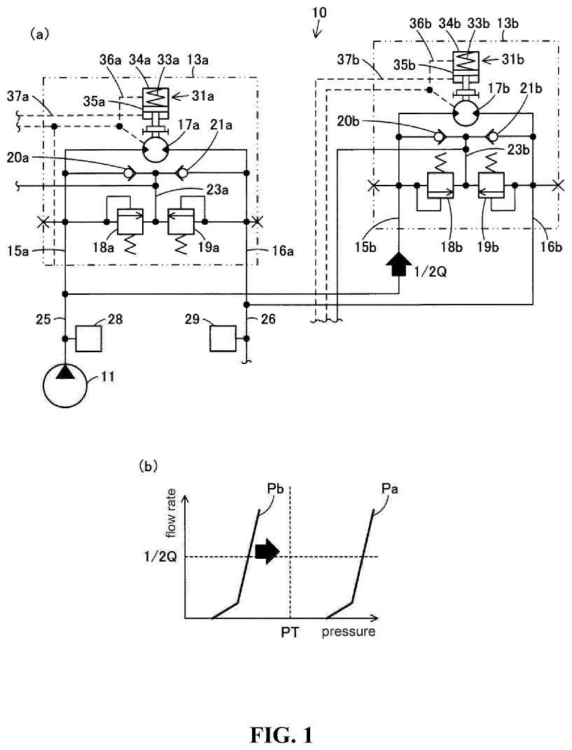

In FIGS. 4, 1 represents a working machine. In the present embodiment the working machine 1 is a machine driven by hydraulic pressure which is actuated by working hydraulic pressure as a working fluid pressure, and in the illustrated example, for example, is a hydraulic excavator type working machine. The working machine 1 of the present embodiment is, for example, a large working machine of 49 tons or more.

The working machine 1 is a swivel-type working machine including a lower traveling body 3 and an upper swing body 4 which is a swing body that is rotatably provided in the lower traveling body 3. The upper swing body 4 is equipped with a cab 5, which is a driving cab, and a working device 6. The work device 6 is axially connected to the upper swing body 4 on a side of the cab 5. In addition, the upper swing body 4 is provided with a machine room 7 containing an engine, a pump, a control valve, etc., and various tanks such as a hydraulic oil tank and a fuel tank are provided on a side opposite to the cab 5 with the working device 6 between them, and a counter weight 8 is mounted at the end opposite to the working device 6 with respect to the machine room 7 and the various tanks.

The hydraulic circuit 10, which is a fluid pressure circuit used in the working machine 1, as shown in FIG. 1(a), supplies the hydraulic oil sucked up and discharged from the hydraulic oil tank by the pump (main pump) 11 driven by the engine to a hydraulic actuator, which is a fluid pressure actuator, and controls the flow rate and direction of the supplied hydraulic oil by a control valve operated in response to the operation of an operator such as a lever or a pedal mounted on the cab 5 shown in FIG. 4, so that it is possible to perform various kinds of work by the work device 6, such as front and rear of the driving by the lower traveling body 3, stopping the swiveling and swiveling of the lower traveling body 3 on the upper swing body 4.

Returning to FIG. 1(a), the pump 11 is connected to a plurality of, for example, paired, swing motor units 13a, 13b via a control valve. The swing motor unit 13a is connected between the output passages 15a, 16a in which hydraulic oil is supplied from the pump 11, one swing motor 17a, the relief valves 18a, 19a paired in opposite directions to each other, and the check valves 20a, 21a for make-up paired in opposite directions to each other, and the make-up passages 23a are connected between the relief valves 18a, 19a and between the check valves 20a, 21a. Likewise, the swing motor unit 13b is connected between the output passages 15b, 16b in which the hydraulic oil is supplied from the pump 11, one swing motor 17b, the relief valves 18b, 19b paired in opposite directions to each other, and the check valves 20b, 21b for make-up paired in opposite directions to each other, and the make-up passages 23b are connected between the relief valves 18b, 19b and between the check valves 20b, 21b. The make-up passages 23a, 23b are connected to the tank, for example, via an oil cooler or a check valve with a spring.

The output passages 15a, 15b and the output passages 16a, 16b are switched so that, via the control valve, one is connected to the passage 25 and the other to the passage 26. The output passage 15b is branched from the output passage 15a and is longer than the output passage 15a. The output passage 16b is also branched from the output passage 16a and is longer than the output passage 16a. Therefore, the swing motor 17a is closer to the pump 11 than the swing motor 17b, and the supply line of the hydraulic oil from the pump 11 is shorter. In addition, before the hydraulic oil branches to the swing motor 17b, a large flow rate (the flow rate of the two swing motors 17a, 17b) flows into the output passages 15a, 16a, so from the viewpoint of pressure loss, the hydraulic piping diameter of the output passages 15a, 16a is generally designed to be larger than the output passages 15b, 16b.

The passages 25, 26 are passages for supplying hydraulic oil from the pump 11 on one side and returning to the tank on the other side by switching the control valve. The passages 25, 26 are provided with pressure sensors 28, 29. In the present embodiment, the pump pressure is basically detected by the pressure sensor 28 and is not a mandatory configuration for the pressure sensor 29.

The swing motors 17a, 17b are hydraulic motors as fluid pressure motors that enable the upper swing body 4 (FIG. 4) to swivel left and right relative to the lower traveling body 3 (FIG. 4). The swing motors 17a, 17b are arranged opposite to each other, for example, with respect to the center of rotation of the upper swing body 4 (FIG. 4). The swing motors 17a, 17b are provided with braking means 31a, 31b for braking the rotation of the swing motors 17a, 17b. The braking means 31a, 31b are also referred to as a parking brake mechanism or the like. By stopping the rotation of the swing motors 17a, 17b, the braking means 31a, 31b hold the upper swing body 4 (FIG. 4) in a forced swivel stop state with respect to the lower traveling body 3 (FIG. 4), for example, when the operation of the working machine 1 (FIG. 4) is stopped. In the present embodiment, the brake means 31a and 31b are exemplified by a mechanical brake for mechanically braking the rotation of the swing motors 17a and 17b. For example, each of the braking means 31a, 31b comprise a cylinder 34a, 34b having a brake loading spring 33a, 33b therein, and a piston 35a, 35b that transmits the brake load of the springs 33a, 33b to the swing motor shaft, wherein the spring chambers of the cylinders 34a, 34b are communicated to the tank by the drain passages 36a, 36b, and the piston chambers of the cylinders 34a, 34b are communicable to a common pilot pump via the brake release introductory passages 37a, 37b and the brake release solenoid valve.

The relief valves 18a, 19a and 18b, 19b then set the upper limit of the supply pressure from the pump 11 to their relief pressure by opening and flowing the hydraulic oil from the make-up passages 23a, 23b to the tank to relieve the pressure when the pressure above the set relief pressure is applied. Thus, depending on the relief pressure of the relief valves 18a, 19a and 18b, 19b, the swivel torque of the swing motors 17a, 17b, i.e. the upper swing body 4 (FIG. 4), is set. The relief valves 18a, 19a and 18b, 19b are variable relief valves, for example, electromagnetic variable relief valves in which the relief pressure is set according to the current value.

The check valves 20a, 21a and 20b, 21b open in response to a pressure difference between the output passages 15a, 16a and 15b, 16b and the make-up passages 23a, 23b, and replenish the hydraulic oil from the tank to the output passages 15a, 16a or the output passages 15b, 16b (on the swing motor 17a, 17b side) via the make-up passages 23a, 23b to prevent the occurrence of a vacuum due to inertial rotation of the upper swing body 4 (FIG. 4) when the rotation of the swive motors 17a, 17b is stopped.

In FIGS. 1 to 3, hydraulic circuits connecting hydraulic actuators such as hydraulic cylinders and hydraulic motors other than the swing motor 15 and the pump 11 are omitted.

Next, a method for adjusting the relief pressure of the relief valve according to the illustrated embodiment will be described.

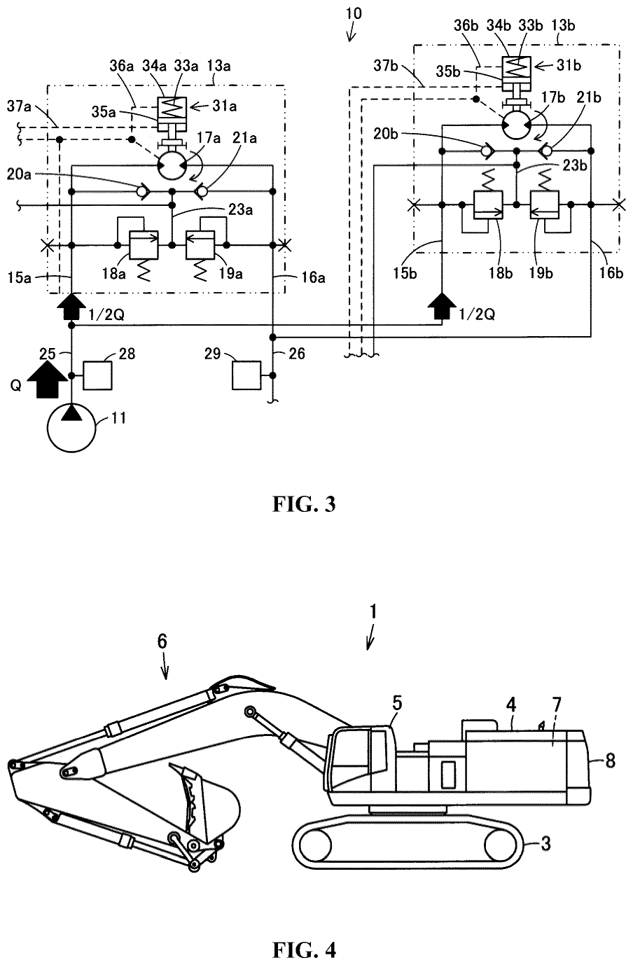

As shown in FIG. 3, during the actual rotation of the upper swing body 4 (FIG. 4), the hydraulic oil discharged from the pump 11 is equally distributed to the two swing motors 17a, 17b, which are balanced by the swing motors 17a, 17b rotating at the same rotational speed.

In this way, in order for the hydraulic oil discharged from the pump 11 to be equally distributed to the two swing motors 17a, 17b, the relief pressure of the relief valves 18a, 19a for the swing motor 17a and the relief pressure of the relief valves 18b, 19b for the swing motor 17b must be set to the same or substantially the same target pressure set in advance. If these relief pressure is different, the flow balance will be unbalanced because the hydraulic oil discharged from the pump 11 will flow more to the swing motor where the relative pressure is lower.

However, when trying to set the relief pressure of the relief valves 18a, 19a and the relief pressure of the relief valves 18b, 19b for the swing motor 17b while actually flowing and driving the hydraulic oil to the swing motors 17a, 17b, it is desirable to set the relief pressure with the swing motors 17a, 17b forced to stop by the braking means 31a, 31b, since the rotation of the swing motors 17a, 17b causes the upper swing body 4 (FIG. 4) to swivel, especially in the case of the large working machine 1 (FIG. 4), which requires a large amount of space.

However, in the state where the swing motors 17a, 17b are forced to stop, when the hydraulic oil is delivered simultaneously from the pump 11 to the swing motors 17a, 17b, due to the influence of the piping pressure loss, that is, the length of the supply line of the hydraulic oil from the pump 11, the flow rate of the hydraulic oil is biased between the swing motor 17a side and the swing motor 17b side, and thus it is difficult to set the relief pressure with high accuracy.

Therefore, in the present embodiment, the flow rate of the hydraulic oil from the pump 11 is throttled to less than or equal to the maximum flow rate of the swing motors 17a, 17b, and the relief pressure can be set with high accuracy by prioritizing the setting of the relief pressure and concentrating the entire flow rate on one side by means of the relief valves 18a, 19a and 18b, 19b.

In other words, the step of forcibly stopping the rotation of each swing motor and adjusting the relief pressure of the relief valve for the swing motor to be adjusted is performed by sequentially switching the relief valve for the swing motor to be adjusted while supplying hydraulic oil from the pump 11 at a flow rate lower than the maximum flow rate of the swing motor at a state where the relief pressure for the swing motor to be adjusted is lower than the relief pressure for the other swing motors, preferably lower than the target pressure.

Specifically, in the present embodiment having a pair of swing motors 17a, 17b, first, in a state where the rotation of the swing motors 17a, 17b is forcibly stopped by the braking means 31a, 31b, as a first step, the relief pressure of the relief valve for one swing motor is set to a higher pressure than the relief pressure of the relief valve for the other swing motor, and the relief pressure of the relief valve for the other swing motor is adjusted while squeezing the flow rate below the maximum flow rate of the swing motor and supplying hydraulic oil from the pump 11.

In this case, it is preferable that one swing motor is on the side where the supply line of the hydraulic oil from the pump 11 is short, as the swing motor 17a in the present embodiment, and the other swing motor is on the side where the supply line of the hydraulic oil from the pump 11 is long, being the swing motor 17b in the present embodiment.

That is, as a first step, as shown in FIG. 1(a) and 1(b), the relief pressure Pa of the relief valves 18a, 19a for the swing motor 17a with a short supply line of hydraulic oil from the pump 11 is set and fixed at a higher pressure than the relief pressure Pb of the relief valves 18b, 19b for the swing motor 17b with a long supply line of hydraulic oil from the pump 11, and the relief pressure Pb of the relief valves 18b, 19b of the swing motor 17b is adjusted to the target pressure PT while squeezing the flow rate from the pump 11 to less than half of the sum Q of the maximum flow rates of the swing motors 17a, 17b to supply the hydraulic oil. In this way, since the relief pressure Pb of the relief valves 18b, 19b for the swing motor 17b is lower than the relief pressure Pa of the relief valves 18a, 19a for the swing motor 17a, the hydraulic oil discharged from the pump 11 flows substantially the entire flow rate to the swing motor 17b side.

At this time, the flow rate of the pump 11 is assumed to be a flow rate that flows to the swing motor 17b during actual rotation, that is, a flow rate of ½Q or less, which is the maximum flow rate of the swing motor 17 b.

However, it is possible to accurately set the relief pressure of the relief valves 18b, 19b to the target pressure during actual rotation by considering the increase in the relief pressure due to the increase in the relief volume or flow rate, that is, the influence of the override characteristic, preferably ½Q. When squeezing the flow rate of the hydraulic oil from the pump 11, it is preferable that the control valve is basically fully open and the discharge flow rate of the pump 11 itself is squeezed so as not to affect the pressure loss caused by the control valve as much as possible in the setting of the relief pressure.

In this embodiment, the relief pressure is adjusted while the pump pressure is monitored by the pressure sensor 28. That is, the relief pressure of the relief valve 18b is set depending on whether the pump pressure detected by the pressure sensor 28 is the target pressure. The relief pressure of the relief valve 19b is also set according to whether the pump pressure detected by the pressure sensor 28 is the target pressure.

It should be noted that when the relief pressure of the relief valve 18b is set and when the relief pressure of the relief valve 19b is set, the supply direction of the hydraulic oil from the pump 11 is reversed by the control valve.

Then, as a second step, the relief pressure of the relief valve for one swing motor is set to be lower than the relief pressure of the relief valve for the other swing motor adjusted in the first step, and the relief pressure of the relief valve for one swing motor is adjusted while squeezing the flow rate and discharging the hydraulic oil than the sum of the maximum flow rates of the swing motor paired from the pump 11.

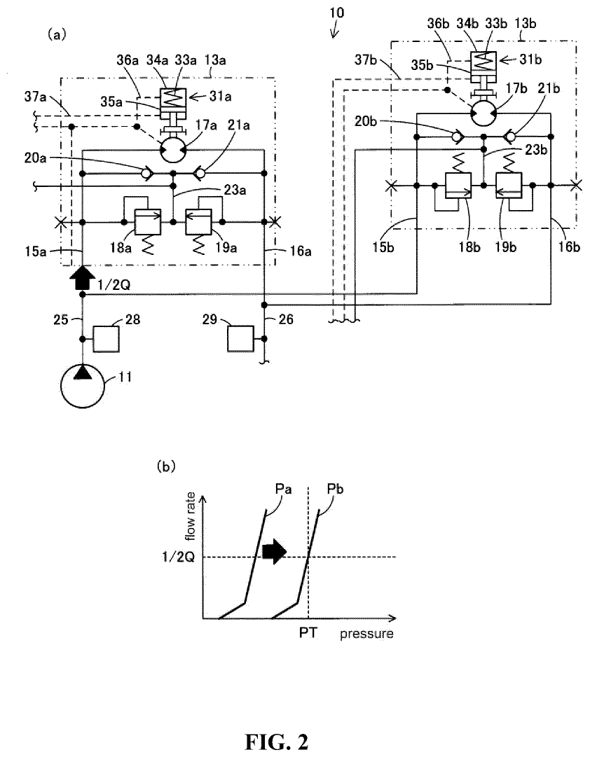

As described above, in the present embodiment, one swing motor is the swing motor 17a and the other swing motor is the swing motor 17b. In the second step, as shown in FIG. 2(a) and 2(b), the relief pressure Pa of the relief valves 18a, 19a for the swing motor 17a is set to a lower pressure than the relief pressure Pb of the relief valves 18b, 19b for the swing motor 17b adjusted in the first step, and the relief pressure Pa of the relief valves 18a, 19a for the swing motor 17a is adjusted to the target pressure PT while squeezing the flow rate from the pump 11 to less than half the sum of the maximum flow rate Q of the swing motors 17a, 17b and discharging the hydraulic oil. In this way, since the relief pressure Pa of the relief valves 18a, 19a for the swing motor 17a is lower than the relief pressure Pb of the relief valves 18b, 19b for the swing motor 17b, the hydraulic oil discharged from the pump 11 flows substantially the entire flow rate to the swing motor 17a side.

At this time, the flow rate of the pump 11 may be the same as or different from the first step if it is the flow rate flowing to the swing motor 17a during actual rotation, that is, a flow rate of ½Q or less, which is the maximum flow rate of the swing motor 17a. Preferably, as in the first step, it is possible to accurately set the relief pressure of the relief valves 18a and 19a to the target pressure during actual rotation by considering the override characteristics of the relief valve to ½Q. When squeezing the flow rate of the hydraulic oil from the pump 11, it is preferable that the control valve is basically fully open and the discharge flow rate of the pump 11 itself is squeezed so as not to affect the pressure loss caused by the control valve as much as possible in the setting of the relief pressure.

In this embodiment, the relief pressure is adjusted while the pump pressure is monitored by the pressure sensors 28, 29. In other words, the relief pressure of the relief valve 18a is set according to whether the pump pressure detected by the pressure sensor 28 is the target pressure. In addition, the relief pressure of the relief valve 19a is set according to whether the pump pressure detected by the pressure sensor 28 is the target pressure.

Note that when the relief pressure of the relief valve 18a is set and when the relief pressure of the relief valve 19a is set, the supply direction of the hydraulic oil from the pump 11 is reversed by the control valve.

In this way, the relief pressure of the relief valves for the plurality of swing motors is set to the priority order, and the total flow rate is concentrated on the relief valve for the swing motor to be adjusted, so that the relief pressure of each relief valve can be set with high accuracy without rotating the upper swing body 4.

In the present embodiment, the relief pressure of the relief valves 18a and 19a for the swing motor 17a and the relief valves 18b and 19b for the swing motor 17b is set to a priority order, and the entire flow rate is concentrated on one of the relief valves 18a, 19a, and relief valve 18b, 19b, such that the relief pressure of the relief valves 18a, 19a and the relief valves 18b, 19b can set with high accuracy, without rotating the upper swing body 4.

In addition, if, for example, the relief pressure of the relief valves 18a, 19a of the swing motor 17a on the side close to the pump 11, that is, the supply line of the hydraulic oil is short, is set first, and then the relief pressure of the relief valves 18b, 19b of the swing motor 17b on the side far from the pump 11, that is, the supply line of the hydraulic oil is long, is set. In this case, when setting the relief pressure of the relief valve 18b, 19b, in accordance with the increase of the pump pressure, the influence of the pressure loss of the supply line of the hydraulic oil to the swing motor 17b side makes it easier for the hydraulic oil from the pump 11 to flow to the relief valves 18a and 19a side where the relief pressure was previously set, and to flow all the hydraulic oil to the relief valves 18b and 19b side during pressure adjustment. In addition, the relief pressure of the relief valves 18b, 19b on the swing motor 17b side, which is a side where the pressure loss is likely to be greater due to the smaller hydraulic piping diameter of the supply line compared to the swing motor 17a side and the position farther from the pump 11, may not be detected even when the relief pressure of the relief valves 18b, 19b on the swing motor 17b side is significantly lower. With regard to this, in this embodiment, the relief pressure of the relief valves 18b, 19b of the swing motor 17b whose pressure loss is relatively large farther away from the pump 11 is set first, and then the relief pressure of the relief valves 18a, 19a of the swing motor 17a whose pressure loss is relatively small closer to the pump 11 is set. As a result, when the relief pressure of the relief valves 18a and 19a for the swing motor 17a is set, the pressure loss of the supply line of the hydraulic oil is less influenced by the pressure of the hydraulic fluid, and the total amount of the hydraulic oil from the pump 11 can be supplied to the relief valves 18a and 19a side before the end of the pressure adjustment, so that the change in the pump pressure can be regarded as a change in relief pressure of the relief valves 18a and 19A. Accordingly, by adjusting the pressure in the order of the present embodiment, the pressure can be controlled in the state where the pressure loss of the supply line of the hydraulic oil is as small as possible, and the relief pressure can be set to a higher accuracy.

Furthermore, by setting the flow rate of the hydraulic oil supplied in the first and second steps to ½Q, which is the maximum flow rate of each swing motor 17a, 17b, the relief pressure can be set at the maximum state of the flow rate supplied to the swing motor 17a or the swing motor 17b during the actual swivel of the upper swing body 4. Therefore, when the upper swing body 4 is actually swiveling, it is possible to obtain the swivel torque as intended.

As a result, sufficient acceleration torque and brake torque of the upper swing body 4 can be ensured, and the upper swing body 4 can be reliably swiveled in the inclined direction at the slope, and the swivel flow of the upper swing body 4, that is, the inertial rotation at the time of stopping, can be reduced.

### INDUSTRIAL APPLICABILITY

The present invention may be utilized in the industry for manufacturers engaged in manufacturing and sales industries of working machines having a swinging body and the like.

1. A method for adjusting relief pressure of a relief valve for a plurality of swing motors to swivel a swing body of a working machine, comprising:
sequentially switching the relief valve for the swing motor to be adjusted; and
performing a process of forcibly stopping a rotation of each swing motor, and adjusting the relief pressure of the relief valve for the swing motor to be adjusted while supplying working fluid from a pump at a flow rate lower than a maximum flow rate of the swing motor at a state where the relief pressure of the relief valve for the swing motor to be adjusted is lower than the relief pressure of the relief valve for other swing motors.

2. The method for adjusting relief pressure of a relief valve for a swing motor according to claim 1, wherein:
the swing motor is set in pairs,
with the rotation of each swing motor forcibly stopped,
setting the relief pressure of the relief valve for one swing motor to higher pressure than the relief pressure of the relief valve for the other swing motor, to adjust the relief pressure of the relief valve for the other swing motor while supplying the working fluid from the pump at a flow rate less than or equal to the maximum flow rate of the swing motor;
setting the relief pressure of the relief valve for one swing motor to lower pressure than the relief pressure of the relief valve for the other swing motor adjusted in the first step, to adjust the relief pressure of the relief valve for one swing motor while supplying the working fluid from the pump with a flow rate less than or equal to the maximum flow rate of the swing motor.

3. The method for adjusting relief pressure of a relief valve for a swing motor according to claim 1, wherein:
one swing motor has a shorter supply line for working fluid from the pump than the other swing motor.

4. The method for adjusting relief pressure of a relief valve for a swing motor according to claim 1, wherein:
the flow rate of the working fluid supplied when adjusting the relief pressure is the maximum flow rate of the swing motor.

5. The method for adjusting relief pressure of a relief valve for a swing motor according to claim 2, wherein:
the flow rate of the working fluid supplied when adjusting the relief pressure is the maximum flow rate of the swing motor.

6. The method for adjusting relief pressure of a relief valve for a swing motor according to claim 3, wherein:
the flow rate of the working fluid supplied when adjusting the relief pressure is the maximum flow rate of the swing motor.
